(19) United States
(12) Patent Application Publication
(10) Pub. No.: US 2025/0222436 A1
(43) Pub. Date: Jul. 10, 2025

(54) COMPOSITE CATALYST, AIR PURIFICATION DEVICE INCLUDING THE SAME, AND METHOD OF PREPARING THE COMPOSITE CATALYST

(71) Applicant: Samsung Electronics Co., Ltd., Suwon-si (KR)

(72) Inventors: Mijong Kim, Suwon-si (KR); Dongjin Ham, Suwon-si (KR); Hyeonsu Heo, Suwon-si (KR); Min Seok Koo, Suwon-si (KR); Hyun Chul Lee, Suwon-si (KR); Jonghyun Ha, Suwon-si (KR)

(21) Appl. No.: 18/675,887

(22) Filed: May 28, 2024

(30) Foreign Application Priority Data
Jan. 8, 2024 (KR) 10-2024-0003112

(51) Int. Cl. B01J 23/42; B01D 53/86; B01J 21/02; B01J 21/06; B01J 35/00; B01J 37/02; B01J 37/08

(52) U.S. Cl. CPC B01J 23/42; B01D 53/8668; B01J 21/02; B01J 21/063; B01J 35/19; B01J 37/0244; B01J 37/08; B01D 2255/1021; B01D 2255/9022; B01D 2257/708; B01D 2258/06

(57) ABSTRACT

A composite catalyst, an air purification device including the same, and a method of preparing the composite catalyst, wherein the composite catalyst includes a carrier including an oxide of a first metal, a second metal supported on the carrier, and an oxide of a third metal supported on the carrier, wherein an electronegativity of the first metal is less than or equal to an electronegativity of the third metal.

### CROSS-REFERENCE TO RELATED APPLICATION

This application is based on and claims priority to Korean Patent Application No. 10-2024-0003112, filed on Jan. 8, 2024, in the Korean Intellectual Property Office and all benefits accruing therefrom under 35 U.S.C. § 119, the content of which is herein incorporated by reference in its entirety.

### BACKGROUND

### 1. Field

The disclosure relates to a composite catalyst, an air purification device including the same, and a method of preparing the composite catalyst.

### 2. Description of the Related Art

In order to remove pollutants in the air, methods of adsorbing and removing gas pollutants have been used. The methods can include applying adsorbents with a wide specific surface area (for example, activated carbon) to air cleaning filters.

Drawbacks of adsorbing/removing technologies can include desorption of the adsorbed gas contaminants to cause secondary pollution, or the requirement of a separate regeneration process of heating adsorbents to a high temperature in order to reuse the adsorbents. Further disadvantages can include short replacement cycles and the performance of adsorbents may deteriorate rapidly in moist conditions.

In place of adsorbing/removing technologies, technologies adopting methods of removing pollutants in the air with various catalysts, or decomposing/converting pollutants in the air into harmless substances have gained interest.

There remains a need for a catalyst that does not cause secondary pollution due to desorption, does not require a separate regeneration process, and is capable of continuously purifying air with high efficiency.

### SUMMARY

An aspect provides a composite catalyst with improved pollutant decomposition and/or removal performance and an improved reaction rate, an air purification device including the same, and a method of preparing the composite catalyst.

Additional aspects will be set forth in part in the description which follows and, in part, will be apparent from the description, or may be learned by practice of the presented embodiments of the disclosure.

According to an aspect, a composite catalyst includes a carrier including an oxide of a first metal, a second metal supported on the carrier, and an oxide of a third metal supported on the carrier, wherein an electronegativity of the first metal is less than or equal to an electronegativity of the third metal.

According to another aspect, an air purification device may include a housing and the composite catalyst, wherein the catalyst is disposed in the housing.

According to another aspect, a method of preparing a composite catalyst includes disposing a second metal and an oxide of a third metal on a carrier including an oxide of a first metal to provide the composite catalyst.

According to another aspect, a method for purifying air may include providing a composite catalyst, contacting an unpurified air flow including a first compound with the composite catalyst, and removing the first compound from the unpurified air flow with the composite catalyst to provide a purified air flow.

### BRIEF DESCRIPTION OF THE DRAWINGS

The above and other aspects, features, and advantages of certain embodiments will be more apparent from the following description taken in conjunction with the accompanying drawings, in which:

FIG. 1 is a scanning electron microscope image of a composite catalyst (e) of Comparative Synthesis Example 2-1;

FIG. 2 is a scanning electron microscope image of a composite catalyst (f) of Synthesis Example 2-1;

FIG. 3 is a schematic view of a catalytic filter according to an embodiment;

FIG. 4 is a front view of an inlet side for unpurified air in the catalytic filter of FIG. 3;

FIG. 5 is a front view of an outlet side for purified air in the catalytic filter of FIG. 3;

FIG. 6 is a cross-sectional view taken along line 4-4′ of FIG. 4, which illustrates the catalytic filter; and

FIG. 7 is an enlarged cross-sectional view of a first portion (A1) of FIG. 6.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Since the disclosure can apply various transformations and have various embodiments, specific embodiments will be illustrated in the drawings and described in detail in the detailed description. However, it should be understood that this is not intended to limit the disclosure to specific embodiments, and includes all transformations, equivalents, and substitutes included in the spirit and scope of the disclosure. In describing the disclosure, when it is determined that the specific description of the known related art unnecessarily obscures the gist of the disclosure, the detailed description thereof will be omitted.

It will be understood that, although the terms “first,” “second,” and “third” may be used herein to describe various elements, these elements should not be limited by these terms. These terms are only used to distinguish one element from another element and not used to limit order or types of elements.

In the present specification, when a portion of a layer, film, region, plate, or the like is described as being “on” or “above” another portion, it may include not only the meaning of “immediately on/under/to the left/to the right in a contact manner,” but also the meaning of “on/under/to the left/to the right in a non-contact manner.”

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

An expression used in the singular encompasses the expression of the plural, unless it has a clearly different meaning in the context. Hereinafter, unless explicitly described to the contrary, it is to be understood that the terms such as “including,” “having,” and “comprising” are intended to indicate the existence of the features, numbers, steps, actions, components, parts, ingredients, materials, or combinations thereof disclosed in the specification and are not intended to preclude the possibility that one or more other features, numbers, steps, actions, components, parts, ingredients, materials, or combinations thereof may exist or may be added.

Whenever a range of values is recited, the range includes all values that fall within the range as if expressly written, and the range further includes the boundaries of the range. Thus, a range of “X to Y” includes all values between X and Y and also includes X and Y.

The term used herein is intended to describe only a specific embodiment and is not intended to limit the present inventive concept. The term “or” refers to “and/or.” As used herein, the term “and/or” includes any and all combinations of one or more of associated listed items. It will be further understood that the terms “comprise” and/or “comprising” or “include” and/or “including” when used in this specification, specify the presence of stated features, regions, integers, steps, operations, and elements.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, unless otherwise defined, the term “size” of particles refers to the “particle diameter” of particles.

As used herein, the term “particle diameter” of particles refers to an average diameter when particles are spherical and refers to an average major axis length when particles are non-spherical. A particle diameter of particles may be measured by using a particle size analyzer (PSA). A “particle diameter” of particles is, for example, an “average particle diameter.” An average particle diameter refers to, for example, a median particle diameter (D50). The median particle diameter (D50) is a particle size corresponding to a 50% cumulative volume when a particle size distribution measured through a laser diffraction method is calculated from particles having a smaller particle size. Alternatively, an “average particle diameter” may be measured from a scanning electron microscope (SEM) image or a transmission electron microscope (TEM) image manually or using software.

As used herein, a substituent may be derived by substitution of at least one hydrogen atom in an unsubstituted mother group with another atom or a functional group. Unless stated otherwise, when any functional group is deemed to be “substituted,” it means that the functional group is substituted with at least one substituent selected from a C1-C40 alkyl group, a C2-C40 alkenyl group, a C2-C40 alkynyl group, a C3-C40 cycloalkyl group, a C3-C40 cycloalkenyl group, and a C7-C40 aryl group. When it is described that a functional group is “optionally substituted,” it is meant that the functional group may be substituted with the above-described substituent.

As used herein, “a” and “b” in the term “Ca-Cb” denote the number of carbon atoms in a particular functional group. That is, the functional group may include “a” to “b” carbon atoms. For example, a “C1 to C4 alkyl group” refers to an alkyl group having 1 to 4 carbon atoms, that is, CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

As used herein, a particular radical may refer to a mono-radical or a di-radical depending on the context. For example, when a substituent needs two binding sites for binding with the rest of the molecule, the substituent may be understood as a di-radical. For example, a substituent specified as an alkyl group that needs two binding sites may include a di-radical such as —CH₂—, —CH₂CH₂—, —CH₂CH(CH₃)CH₂—. The term “alkylene” as used herein clearly indicates that the radical is a di-radical.

As used herein, the terms “alkyl group” or “alkylene group” refers to a branched or unbranched aliphatic hydrocarbon group. In an embodiment, an alkyl group may be substituted or unsubstituted. Examples of the alkyl group may include a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, a cycloheptyl, and the like, but one or more embodiments are not necessarily limited thereto. Each of the examples of the alkyl group may be optionally substituted or unsubstituted. In an embodiment, the alkyl group may have 1 to 6 carbon atoms. For example, a C1-C6 alkyl group may be methyl, ethyl, propyl, isopropyl, butyl, iso-butyl, sec-butyl, pentyl, 3-pentyl, hexyl, or the like, but is not necessarily limited thereto.

As used herein, the term “alkenyl group” refers to a hydrocarbon group including 2 to 20 carbon atoms with at least one carbon-carbon double bond. Examples of the alkenyl group may include an ethenyl group, a 1-propenyl group, a 2-propenyl group, a 2-methyl-1-propenyl group, a 1-butenyl group, a 2-butenyl group, a cyclopropenyl group, a cyclopentenyl group, a cyclohexcenyl group, and a cycloheptenyl group, but one or more embodiments are not limited thereto. In an embodiment, the alkenyl group may be substituted or unsubstituted. In an embodiment, the alkenyl group may have 2 to 40 carbon atoms.

As used herein, the term “alkynyl group” refers to a hydrocarbon group including 2 to 20 carbon atoms with at least one carbon-carbon triple bond. Examples of the alkynyl group may include an ethynyl group, a 1-propynyl group, a 1-butynyl group, and a 2-butynyl group, but one or more embodiments are not limited thereto. In an embodiment, the alkynyl group may be substituted or unsubstituted. In an embodiment, the alkynyl group may have 2 to 40 carbon atoms.

As used herein, the term “cycloalkyl group” refers to a carbocyclic ring or ring system that is fully saturated. For example, the cycloalkyl group may refer to cyclopropyl, cyclobutyl, cyclopentyl, cyclohexyl, or the like.

As used herein, the term “aromatic” may refer to a ring or ring system with a conjugated π (pi) electron system and may include a carbocyclic aromatic group (for example, a phenyl group) and a heterocyclic aromatic group (for example, pyridine). When the entire ring system is aromatic, the term includes a single ring or a fused polycyclic ring (that is, a ring that share adjacent pairs of atoms).

As used herein, the term “aryl group” refers to an aromatic ring of which a ring backbone includes only carbon, a ring system (that is, two or more fused rings sharing two adjacent carbon atoms), or a plurality of aromatic rings linked to each other through a single bond, —O—, —S—, —C(═O)—, —S(═O)₂—, —Si(Ra)(Rb)-, wherein Ra and Rb are each independently a C1-C10 alkyl group), a C1-C10 alkylene group unsubstituted or substituted with a halogen, or —C(═O)—NH—. When the aryl group is a ring system, each ring in the ring system is aromatic. For example, the aryl group may include a phenyl group, a biphenyl group, a naphthyl group, a phenanthrenyl group, a naphthacenyl group, or the like, but one or more embodiments are not limited thereto. The aryl group may be substituted or unsubstituted.

As used herein, the term “arylene group” refers to an aryl group that requires two or more binding sites. A tetravalent arylene group is an aryl group that requires four binding sites, and a divalent arylene group is an aryl group that requires two binding sites. For example, the arylene group may be —C₆H₅—O—C₆H₅— or the like.

In the present, the term “heteroaryl group” refers to an aromatic ring system including one ring, a plurality of fused rings, or a plurality of rings linked to each other through a single bond, —O—, —S—, —C(═O)—, —S(═O)₂—, —Si(Ra)(Rb)-, wherein Ra and Rb are each independently a C1-C10 alkyl group, a C1-C10 alkylene group unsubstituted or substituted with a halogen, or —C(═O)—NH—, in which at least one ring atom is a heteroatom, i.e., not carbon. In the fused ring system, at least one heteroatom may be present in only one ring. In the fused ring system, at least one heteroatom may be present in only one ring. For example, the heteroatom may include oxygen, sulfur, and nitrogen, but one or more embodiments are not necessarily limited thereto. For example, the heteroaryl group may be a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, an indolyl group, or the like, but is not limited thereto.

As used herein, the term “heteroarylene group” refers to a heteroaryl group that requires two or more binding sites. A tetravalent heteroarylene group is a heteroaryl group that requires four binding sites, and a divalent heteroarylene group is a heteroaryl group that requires two binding sites.

As used herein, the terms “aralkyl group” or “alkylaryl group” refers to an aryl group connected linked to a substituent via an alkylene group, like a C7-C14 aralkyl group. Examples of the aralkyl group or alkylaryl group may include a benzyl group, a 2-phenylethyl group, a 3-phenylpropyl group, and a naphthylalkyl group, but one or more embodiments are not limited thereto. In an embodiment, the alkylene group may be a lower alkylene group (that is, a C1-C4 alkylene group).

As used herein, the terms “cycloalkenyl group” refers to a carbocyclic ring or ring system with at least one double bond, that is, a ring system without an aromatic ring. For example, the cycloalkenyl group may be a cyclohexenyl group.

As used herein, the term “heterocyclyl group” is a non-aromatic ring or ring system including one or more heteroatoms in its cyclic backbone.

As used herein, the term “halogen” refers to a stable atom belonging to Group 17 of the periodic tables of elements, for example, fluorine, chlorine, bromine, or iodine. In particular, the halogen may be fluorine and/or chlorine.

Unless otherwise defined, all terms (including technical and scientific terms) used herein have the same meaning as commonly understood by one or ordinary skill in the art to which the disclosure belongs. In addition, it will be further understood that terms, such as those defined in commonly used dictionaries, should be interpreted as having a meaning that is consistent with their meaning in the context of the relevant art and the disclosure and will not be interpreted in an idealized sense unless expressly so defined herein. Also, the terms should not be interpreted in an overly formal sense.

Hereinafter, embodiments will be described in detail with reference to the accompanying drawings, wherein like reference numerals denote substantially the same or corresponding components throughout the drawings, and a redundant description thereof will be omitted. In the drawings, the thicknesses of layers and regions are exaggerated for clarity. Also, in the drawings, the thicknesses of some layers and regions are exaggerated for convenience of description. Meanwhile, embodiments set forth herein are merely examples and various changes may be made therein.

Hereinafter, a composite catalyst, a catalytic filter including the same, an air purification device including the composite catalyst, and a method of preparing the composite catalyst according to embodiments will be described in more detail.

### Composite Catalyst

A composite catalyst according to embodiments may include a carrier including an oxide of a first metal, a second metal supported on the carrier, and an oxide of an oxide of a third metal supported on the carrier, wherein an electronegativity of the first metal is less than or equal to an electronegativity of the third metal.

A size of the carrier may be, for example, about 0.1 nanometers (nm) to about 20 nm, for example, about 1 nm to about 10 nm, and specifically, about 3 nm to about 7 nm. Since the carrier has a size in such a range, the removal performance of the composite catalyst with respect to a volatile organic compound may be further improved. The size of the carrier may be, for example, a diameter of the carrier measured in a SEM image or a TEM image. The size of the carrier may be, for example, an average particle diameter. An average particle diameter may be measured by using, for example, a measuring device using a laser diffraction method or a dynamic light scattering method. An average particle diameter may be measured using a laser scattering particle size distribution meter (for example, LA-920 manufactured by Horiba Corporation) and is a value of a median diameter (D50) when metal oxide particles are accumulated to 50% from small particles in volume conversion.

The carrier may include, for example, irregular particles, spherical particles with an aspect ratio of less than 2, non-spherical particles with an aspect ratio of 2 or greater, or a combination thereof. The aspect ratio of the spherical particles may be, for example, 1.9 or less, 1.5 or less, or 1.2 or less. A sphericity of the spherical particles may be, for example, 0.85 or greater, 0.9 or greater, or 0.95 or greater. A sphericity may be calculated, for example, from ψ=[π^{1/3}(6Vₚ)^{2/3}]/Aₚ, wherein ψ denotes the sphericity, Vₚ denotes a volume of a particle, and Aₚ denotes a surface area of the particle. A circularity of a projected two-dimensional image of the spherical particles may be, for example, 0.85 or greater, 0.9 or greater, or 0.95 or greater. A circularity may be calculated, for example, from C=[4πA]/P², wherein C denotes the circularity, A denotes an area of a particle, and P denotes a perimeter of the particle. The aspect ratio of the non-spherical particles may be, for example, 2 or greater, 2.5 or greater, or 3 or greater. The aspect ratio of the non-spherical particles may be, for example, about 2 to about 100, about 2.5 to about 100, or about 3 to about 100. A sphericity of the non-spherical particles may be less than 0.8. A circularity of a two-dimensional image of the non-spherical particles may be less than 0.8. The non-spherical particles may include, for example, tubular particles, plate-shaped particles, needle-shaped particles, rod-shaped particles, fibrous particles, or a combination thereof.

The carrier may include the oxide of the first metal, and the oxide of the first metal may be different from the oxide of the third metal.

The oxide of the first metal and the oxide of the third metal may be chemically bonded on a surface of the carrier. For example, when the first metal is Ti and the third metal is B, a Ti—O—B bond may be present on the surface of the carrier.

The first metal may include at least one of Al, Si, a transition metal, or a combination thereof. Specifically, the first metal may include Al, Si, Zr, Ti, or a combination thereof. More specifically, the first metal may include Al, Si, Ti, or a combination thereof. In particular, the first metal may include Ti.

In an embodiment, the oxide of the first metal may be represented by a formula of MₐO_{b}, wherein M is Al, Si, Zr, Ti, or a combination thereof, 0<a≤4, and 0<b≤5. Specifically, the oxide of the first metal may be AlₓO_{y}, wherein 0<x≤2 and 0<y≤3, SiO_{y}, wherein 0<y≤2, ZrO_{y}, wherein 0<y≤2, TiO_{y}, wherein 0<y≤2, or any combination thereof. More specifically, the oxide of the first metal may be Al₂O₃, SiO₂, ZrO₂, TiO₂, or any combination thereof. In particular, the oxide of the first metal may be TiO₂.

The second metal may be supported on the carrier.

A size of the second metal may be about 0.1 nm to about 10 nm, about 0.1 nm to about 7 nm, about 0.5 nm to about 5 nm, or about 1 nm to about 5 nm. For example, the size of the second metal may be about 0.1 nm to about 10 nm, about 0.1 nm to about 5 nm, about 0.1 nm to about 3 nm, or about 0.1 nm to about 2 nm. Since the second metal has a size in such a range, the removal performance of the composite catalyst with respect to a volatile organic compound may be further improved. The size of the second metal may be, for example, a diameter of the second metal measured in a SEM image or a TEM image. The size of the second metal may be, for example, an average particle diameter.

The composite catalyst may be free of a second metal having a size of 100 nm or greater, 50 nm or greater, or 30 nm or greater. For example, the carrier may not include a second metal having a size of 100 nm or greater. “Free” as used herein means that the second metal is excluded from the composite catalyst. Since the composite catalyst does not include the second metal having a size of 100 nm or greater, which is formed by aggregation of a plurality of metal ions and/or a plurality of metal particles, the non-uniformity of a catalytic reaction may be suppressed.

The second metal may include Pt, Pd, Rh, Ru, Ir, V, Mo, Mn, Ni, Co, Ce, Fe, W, Ag, Au, Cu, Sn, or a combination thereof. Specifically, the second metal may include Pt, Pd, Rh, or a combination thereof. More specifically, the second metal may include Pt.

A content of the second metal may be greater than 0 weight percent (wt %), 0.01 wt % or greater, 0.1 wt % or greater, 1 wt % or less, 2 wt % or less, 3 wt % or less, 4 wt % or less, or 5 wt % or less based on the total weight of the composite catalyst. Since the content of the second metal is in such a range, the removal performance of the composite catalyst with respect to a volatile organic compound may be further improved. When the content of the second metal is excessively low, an expected effect may be insignificant. When the content of the second metal is excessively high, an increase in catalytic effect according to an increase in content may be inefficient.

According to an embodiment, the second metal may surround at least a portion of the surface of the carrier.

The oxide of the third metal may be supported on the carrier.

A size of the oxide of the third metal may be about 0.1 nm to about 10 nm, about 0.1 nm to about 7 nm, about 0.5 nm to about 5 nm, or about 1 nm to 5 about nm. For example, the size of the oxide of the third metal may be about 0.1 nm to about 10 nm, about 0.1 nm to about 5 nm, about 0.1 nm to about 3 nm, or about 0.1 nm to about 2 nm. Since the oxide of the third metal has a size in such a range, the removal performance of the composite catalyst with respect to a volatile organic compound may be further improved. The size of the oxide of the third metal may be, for example, a diameter of the oxide of the third metal measured in a SEM image or a TEM image. The size of the oxide of the third metal may be, for example, an average particle diameter.

The composite catalyst may be free of an oxide of a third metal having a size of 100 nm or greater, 50 nm or greater, or 30 nm or greater. For example, the carrier may not include an oxide of a third metal having a size of 100 nm or greater. Since the composite catalyst does not include the oxide of the third metal having a size of 100 nm or greater, which is formed by aggregation of a plurality of metal ions and/or a plurality of metal particles, the non-uniformity of a catalytic reaction may be suppressed.

The third metal may include B, Al, Si, P, V, Cr, Mn, Fe, Co, Ni, Cu, Zn, Ga, Ge, Se, Nb, Mo, Tc, Ru, Rh, Pd, Ag, Cd, In, Sn, Sb, W, Ir, Bi, or a combination thereof. Specifically, the third metal may include B, Al, or a combination thereof. More specifically, the third metal may include B.

In an embodiment, the oxide of the third metal may be represented by a formula of MₐO_{b}, wherein M is B, Al, or a combination thereof, 0<a≤4, and 0<b≤5. Specifically, the oxide of the third metal may be AlₓO_{y}, wherein 0<x≤2 and 0<y≤3, BₓO_{y}, wherein 0<x≤2 and 0<y≤3, or any combination thereof. More specifically, the oxide of the third metal may be Al₂O₃, B₂O₃, or any combination thereof. In particular, the oxide of the third metal may be B₂O₃.

A content of the oxide of the third metal may be greater than 0 wt %, 0.01 wt % or greater, 0.1 wt % or greater, 1 wt % or less, 2 wt % or less, 3 wt % or less, 4 wt % or less, or 5 wt % or less with respect to the total weight of the composite catalyst. More specifically, the content of the oxide of the third metal may be about 0.01 wt % to about 2 wt % based on the total weight of the composite catalyst. Since the content of the oxide of the third metal is in such a range, the removal performance of the composite catalyst with respect to a volatile organic compound may be further improved. When the content of the oxide of the third metal is excessively high, since the oxide of the third metal covers a reaction site of the second metal, the performance of the composite catalyst may deteriorate.

An oxidation catalyst may have advantages that the oxidation catalyst is easier to maintain than an adsorption catalyst, is more energy efficient than a thermal catalyst, and is able to remove a high-flow pollutant with high efficiency as compared with a photocatalyst.

However, since precious metals included in such an oxidation catalyst are expensive, high costs may arise in a large-scale field that requires a large amount of catalysts. In addition, other inexpensive transition metals may not match an activity level of noble metals and thus may not be suitable for use in oxidation catalysts.

Therefore, when an appropriate additive or reaction accelerator is introduced into a metal/metal oxide composite catalyst, the appropriate additive or reaction accelerator may involve the chemical properties of a composite catalyst, and thus, when a volatile organic compound decomposition reaction is promoted, costs according to use of precious metals may be reduced.

Meanwhile, since the electronegativity of the first metal is less than or equal to the electronegativity of the third metal, an electron (e−)-deficient environment may be formed around the oxide of the first metal, and the electron density of the first metal may be decreased. Accordingly, active sites for adsorption of volatile organic compounds and/or oxygen and oxidation reaction of volatile organic compounds may increase. Accordingly, the activity of the composite catalyst including the oxide of the third metal may be improved as compared with a composite catalyst not including the oxide of the third metal.

The oxide of the first metal may allow a first compound, which is included in unpurified air, to be adsorbed. The second metal may undergo an oxidation reaction with the first compound included in unpurified air. In addition, the oxide of the third metal may improve a bond between the carrier and an oxide of the second metal to improve the stability of the composite catalyst. Furthermore, the third metal included in the oxide of the third metal may provide a site at which an oxygen molecule may easily bind to a surface, thereby improving the performance of the composite catalyst.

The composite catalyst may be configured to remove the first compound from an unpurified air flow including the first compound.

The unpurified air flow may include the first compound, and the first compound may include, for example, a volatile organic compound. The volatile organic compound is not particularly limited and may include any material as long as the material may be classified as a volatile organic compound that is harmful to the human body or the environment in the art at home and abroad. The volatile organic compound may include, for example, a polar compound, a non-polar compound, or a combination thereof.

The volatile organic compound may be, for example, the non-polar compound. The non-polar compound may include, for example, an aliphatic hydrocarbon, an aromatic hydrocarbon, or a combination thereof. The aliphatic hydrocarbon and the aromatic hydrocarbon may be unsubstituted or substituted with a substituent. The substituent may be, for example, an alkyl group, an alkenyl group, an alkynyl group, a cycloalkyl group, an aryl group, a heteroaryl group, an aralkyl group, a cycloalkenyl group, a heterocyclyl group, or a halogen. The aliphatic hydrocarbon may include, for example, methane, ethane, propane, butane, pentane, hexane, or a combination thereof. The aromatic hydrocarbon may include, for example, benzene, toluene, xylene, or a combination thereof.

The volatile organic compound may be, for example, a polar compound. The polar compound may include, for example, ammonia (NH₃), an amine compound, an aldehyde compound, a ketone compound, an alcohol compound, a sulfur compound, a thiol compound, a halogenated hydrocarbon, a nitrogen oxide (NOₓ), a sulfur oxide (SOₓ), ozone, or a combinations thereof. The amine compound may include, for example, methylamine, dimethylamine, trimethylamine, ethylamine, aniline, or a combination thereof. The aldehyde compound may include, for example, formaldehyde, acetaldehyde, propiolaldehyde, butyraldehyde, or a combination thereof. The ketone compound may include, for example, dimethyl ketone, methyl ethyl ketone, diethyl ketone, methyl propyl ketone, dipropyl ketone, or a combination thereof. The alcohol compound may include, for example, methanol, ethanol, propanol, isopropanol, butanol, pentanol, hexanol, heptanol, or a combination thereof. The sulfur compound may include, for example, hydrogen sulfide, sulfur dioxide, elemental sulfur, sulfur oxides (SOₓ), or a combination thereof. The thiol compound may include, for example, methanethiol, ethanethiol, 1-propanethiol, 2-propanethiol, propenethiol, butanethiol, tert-butyl mercaptan, thiophenol, or a combination thereof.

The composite catalyst may be mounted in the form of a filter on various indoor and outdoor air purification devices (for example, air purifiers, air purification facilities, and air conditioning equipment) and applied as a volatile organic compound gas removal module and may also be used in indoor and outdoor air purification systems for removing fine dust.

The composite catalyst may further include a solid substrate. The composite catalyst may include, for example, a solid substrate, and a carrier disposed on the solid substrate. The solid substrate is not particularly limited and may include, for example, polymer, ceramic, or metal. The form of the solid substrate is not particularly limited and may be mesh, foam, woven fabric, non-woven fabric, a honeycomb structure, or the like. For example, the carrier and the solid substrate may be disposed to facilitate intersection of an air flow between an upstream side of the air flow stream and a downstream side of the air flow stream. For example, the carrier and the solid substrate may be disposed such that the air flow sequentially passes through one side of the carrier and the solid substrate and the other side opposite the one side. The carrier may be disposed upstream of the solid substrate in the air flow stream. That is, the carrier may be disposed to first come into contact with the air flow as compared with the solid substrate. Alternatively, the carrier and the solid substrate may be disposed in parallel along at least a portion of the air flow stream, for example from the upstream side toward the downstream side of the air flow. For example, the carrier and solid substrate may be disposed such that the air flow moves along one side of the carrier and the solid substrate and/or the other side opposite the one side. The second metal and the oxide of the third metal are supported on the carrier. The composite catalyst including the solid substrate and the carrier disposed on the solid substrate may constitute, for example, a catalyst filter.

For example, the composite catalyst may be mounted in the form of a catalytic filter on various indoor and outdoor air purification devices such as air purifiers, air purification facilities, and air conditioning equipment to remove a volatile organic compound or fine dust from unpurified air.

### Air Purification Device

An air purification device according to another embodiment may include a housing, and the composite catalyst, wherein the composite catalyst is disposed in the housing. Since the air purification device includes the composite catalyst disposed in the housing, unpurified air may be more easily purified. A shape of the housing is not particularly limited, and the housing may have any shape as long as the shape may accommodate the composite catalyst.

The air purification device may include, for example, a housing and a catalytic filter disposed in the housing. The catalytic filter may include a solid substrate and the above-described composite catalyst disposed on the solid substrate. The housing may include an inlet into an air flow stream through which air flows in and an outlet of the air flow stream through which air flows out, and the composite catalyst may be disposed between the inlet and the outlet.

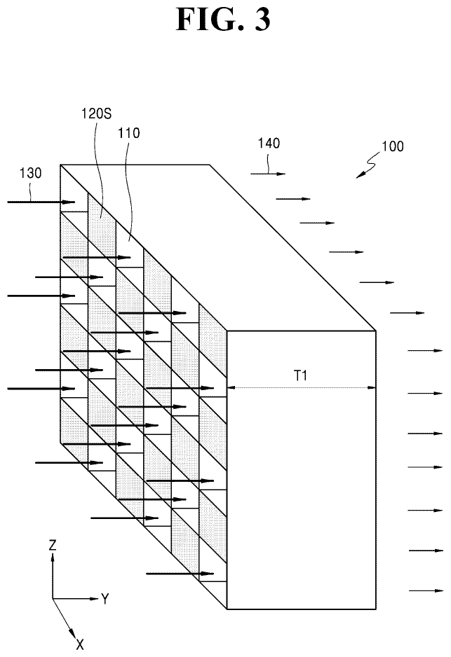

A catalytic filter and an air purification system including the same according to an embodiment will be described in more detail with reference to FIGS. 3 to 7.

Referring to FIG. 3, a catalytic filter 100 may include an inlet side through which unpurified air 130 flows in and an outlet side through which purified air 140 flows out. The unpurified air 130 may include one or more types of first compounds.

The unpurified air 130 may include, for example, a particulate first compound, a gaseous first compound, or a combination thereof. The catalytic filter 100 may have a thickness T1 defined in a direction (Y-axis direction in FIG. 3) from the inlet side to the outlet side.

The catalytic filter 100 may include a plurality of first recessed portions 110 each having an inlet adjacent to the inlet side through which the unpurified air 130 flows in and a bottom adjacent to the outlet side through which the purified air 140 flows out. The unpurified air 130 may flow in the catalytic filter 100 through the plurality of first recessed portions 110. The plurality of first recessed portions 110 may be arranged regularly and/or periodically. For example, the plurality of first recessed portions 110 may be arranged parallel to each other along an X-direction and/or a Z-direction of FIG. 3.

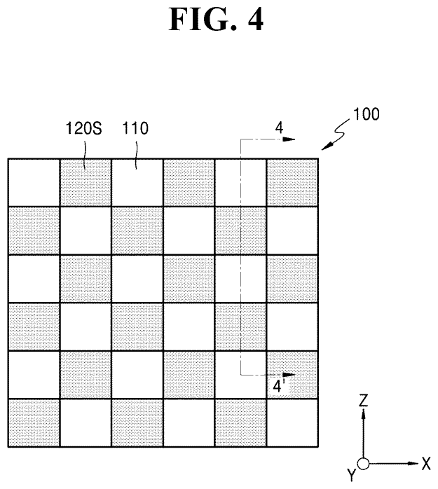

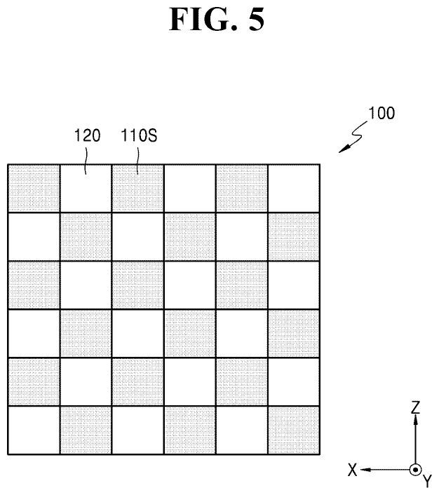

FIG. 4 is a front view of a front side, that is, the inlet side of the catalytic filter 100 of FIG. 3. FIG. 5 is a front view of a rear side, that is, the outlet side of the catalytic filter 100 of FIG. 3. Referring to FIG. 4, the inlet side of the catalytic filter 100 may include the plurality of first recessed portions 110 and a plurality of first sides 120S which are exposed at the inlet side. The plurality of first sides 120S may be arranged regularly and/or periodically. For example, the plurality of first sides 120S may be disposed between the plurality of first recessed portions 110.

The plurality of first sides 120S may be disposed to be spaced apart from each other between the plurality of first recessed portions 110 disposed to be spaced apart from each other along a surface of the inlet side in one direction, for example, in the X direction and/or the Z direction of FIG. 3. The plurality of first recessed portions 110 and the plurality of first sides 120S may be alternately disposed along the surface of the inflow side in one direction, for example, the X direction and/or the Z direction of FIG. 3. One first recessed portion 110 may be surrounded by four first sides 120S, and one first side 120S may be surrounded by four first recessed portions 110.

Referring to FIG. 5, the outlet side of the catalytic filter 100 may include a plurality of second recessed portions 120 and a plurality of second sides 110S which are exposed at the outlet side. The plurality of second recessed portions 120 may be outlets through which the purified air 140 flows out. The purified air 140 flowing out through the second recessed portion 120 may be air in which the first compound is removed from the unpurified air 130 flowing in through the first recessed portion 110 or may be air which includes harmless gas obtained by decomposing the first compound.

The plurality of second recessed portions 120 may be arranged regularly and/or periodically in the X-direction and/or Z-direction of FIG. 5. The plurality of second sides 110S may be arranged regularly. The plurality of second sides 110S may be disposed between the plurality of second recessed portions 120.

The plurality of second sides 110S may correspond to the plurality of first recessed portions 110, and the plurality of second recessed portions 120 may correspond to the plurality of first sides 120S.

Referring to FIGS. 3 to 5, the second side 110S may correspond to a bottom of the first recessed portion 110, and the first side 120S may correspond to a bottom of the second recessed portion 120.

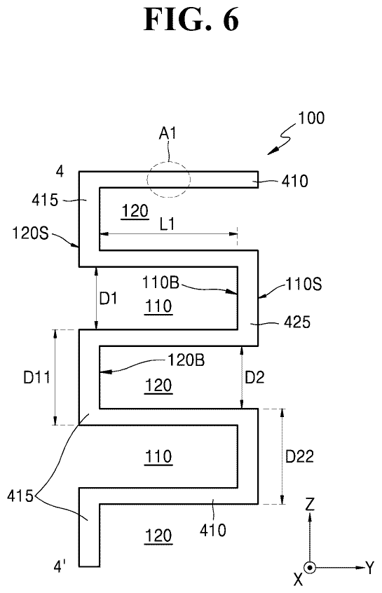

FIG. 6 is a cross-sectional view taken along line 4-4′ of FIG. 4.

The catalytic filter 100 may have a monolithic structure or a monolithic frame. The catalytic filter 100 may have a frame of which the entirety is formed of the same material, for example, a ceramic material, a polymer material, or a metal material. The catalytic filter 100 may have, for example, a single body or monolithic structure of which the entirety is integrally connected. Alternatively, the catalytic filter 100 may be a multi-layer structure or a multi-layer frame. For example, although not shown in the drawing, the catalytic filter 100 may have a multi-layer structure including a solid substrate and a composite catalyst disposed on the solid substrate. Referring to FIG. 6, the catalytic filter 100 may be a structure having a frame in which the plurality of first recessed portions 110 and the plurality of second recessed portions 120 are sequentially disposed in the Z-axis direction. The catalytic filter 100 may include a plurality of horizontal regions 410 and a plurality of vertical regions 415 and 425. The plurality of horizontal regions 410 may be disposed to be spaced apart from each other in the Z-axis direction. The Z-axis direction may correspond to a vertical direction. The plurality of horizontal regions 410 may be disposed parallel to each other in the Y-axis direction. Lengths of the plurality of horizontal regions 410 may be the same or different. The plurality of horizontal regions 410 may be disposed between the plurality of vertical regions 415 and 425. The plurality of horizontal regions 410 may be physically connected to each other through the plurality of vertical regions 415 and 425. The plurality of vertical regions 415 and 425 may be disposed parallel to each other and spaced apart from each other. The plurality of vertical regions 415 and 425 may be disposed to be spaced apart from each other in the Z-axis direction. The Z-axis direction may correspond to the vertical direction. The plurality of vertical regions 415 and 425 may be disposed parallel to each other in the Y-axis direction. Lengths of the plurality of vertical regions 415 and 425 may be the same or different. The plurality of vertical regions 415 and 425 may be disposed between the plurality of horizontal regions 410. The plurality of vertical regions 415 and 425 may be physically connected to each other through the plurality of horizontal regions 410. The plurality of vertical regions 415 and 425 may include a plurality of first vertical regions 415 and a plurality of second vertical regions 425. The plurality of first vertical regions 415 and the plurality of second vertical regions 425 may be arranged to be spaced apart from each other in the Y-axis direction. The plurality of first vertical regions 415 may be disposed to be spaced apart from each other in the Z-axis direction. The plurality of second vertical regions 425 may also be disposed to be spaced apart from each other in the Z-axis direction. The plurality of first vertical regions 415 may be disposed on the inlet side through which the unpurified air 130 is supplied. The plurality of second vertical regions 425 may be disposed on the outlet side through which the purified air 140 flows out.

The plurality of horizontal regions 410 may correspond to walls of the first recessed portions 110 and the second recessed portions 120. Each of the plurality of horizontal regions 410 may be positioned between the first recessed portion 110 and the second recessed portion 120 to serve as a boundary of each of the first recessed portion 110 and the second recessed portion 120. The wall may correspond to a side wall of each of the first recessed portion 110 and the second recessed portion 120. Thicknesses of the plurality of horizontal regions 410 may be the same or different. The thickness of each of the plurality of horizontal regions 410 may be the same as or different from a thickness of each of the plurality of vertical regions 415 and 425. The horizontal regions 410 which serve as the walls of the first recessed portions 110 may be disposed to be spaced apart by a first interval D1 in the Z-axis direction. The horizontal regions 410 which serve as the walls of the second recessed portions 120 may be disposed to be spaced apart from each other by a second interval D2 in the Z-axis direction. The first interval D1 may be the same as or different from the second interval D2. A diameter and/or area of an inlet of the first recessed portion 110 are the same or different from a diameter and/or area of an inlet of the second recessed portion 120. Y-axis direction lengths L1 of the plurality of horizontal regions 410 may be the same or different. A depth of each of the first recessed portion 110 and the second recessed portion 120 may be defined by the Y-axis direction length L1 of the horizontal region 410. The depths of the first recessed portion 110 and the second recessed portion 120 may be the same or different. The plurality of first vertical regions 415 may form the bottoms of the second recessed portions 120. The plurality of second vertical regions 425 may form the bottoms of the first recessed portions 110. A breathability of the bottom of the first recessed portion 110 may be the same as or different from a breathability of the bottom of the second recessed portion 120. A diameter D11 of the first vertical region 415 may be the same as or different from a diameter D22 of the second vertical region 425. A Y-axis direction thicknesses of the first vertical region 415 may be the same as or different from a Y-axis direction thicknesses of the second vertical region 425.

The plurality of horizontal regions 410 and the plurality of vertical regions 415 and 425 may have a single body or monolithic structure of which the entirety is integrally connected and may be formed of the same material.

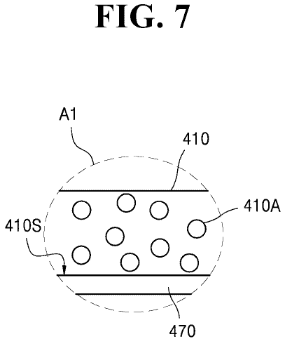

FIG. 7 is an enlarged view of a first portion A1 of the horizontal region 410 of FIG. 6.

Referring to FIG. 7, the horizontal region 410 may include pores 410A. The vertical regions 415 and 425 may or may not include pores.

The horizontal regions 410 and the vertical regions 415 and 425 may include pores, and a pore density of the vertical region 415 and 425 may be higher or lower than a pore density of the horizontal region 410.

For example, the first vertical regions 415 may include pores, and the second vertical regions 425 may not include pores. Alternatively, the first vertical regions 415 may not include pores, and the second vertical regions 425 may include pores.

The first vertical regions 415 and the second vertical regions 425 may include pore, and a pore density of the second vertical regions 425 may be higher or lower than a pore density of the first vertical regions 415.

A catalyst layer 470 including a composite catalyst may be disposed on one side 410S of the horizontal region 410. The catalyst layer 470 may be disposed, for example, in all of the horizontal regions 410 and the vertical regions 415 and 425.

### Method of Preparing Catalyst

Meanwhile, a method of preparing a composite catalyst according to an embodiment may include supporting a second metal and an oxide of a third metal on a carrier including an oxide of a first metal.

For example, the second metal and the oxide of the third metal may be simultaneously supported on the carrier; the second metal may be supported on the carrier before the oxide of the third metal; or the oxide of the third metal may be supported on the carrier before the second metal.

Specifically, the composite catalyst may be prepared through a method of (1) mixing the carrier and a precursor of the oxide of the third metal in an aqueous solution to provide a first mixture and then heat-treating (primary heat treatment) the first mixture in an oxidizing atmosphere to provide a primary heat-treated mixture, and disposing the second metal on the primary heat-treated mixture and then heat-treating (second heat treatment) the second metal disposed on the primary heat-treated mixture to provide the composite catalyst; (2) mixing the carrier, a precursor of the second metal, a reducing agent, and a precursor of the oxide of the third metal in an aqueous solution to provide a second mixture, and then heat-treating the second mixture in an oxidizing atmosphere to provide the composite catalyst; or (3) mixing the carrier, a precursor of the second metal, and a reducing agent in an aqueous solution, and then mixing a precursor of the oxide of the third metal thereto to provide a third mixture then heat-treating the third mixture in an oxidizing atmosphere to provide the composite catalyst.

In an embodiment, the oxide of the third metal may be first disposed on the carrier, and then the second metal may be disposed thereon to secure an active site of the second metal as much as possible, thereby improving the activity of the composite catalyst.

The method of preparing a composite catalyst may further include a heat treatment or multiple heat treatment steps. The heat treatment may be a heat-treating a first composition obtained by disposing the precursor of the second metal and the precursor oxide of the third metal on the carrier or may constitute heat-treating a second composition obtained by further disposing a precursor of the oxide of the third metal on the carrier.

By heat treating the first composition or second composition, the precursor of the oxide of the third metal may be melted to provide a melted oxide of the third metal, and the melted oxide of the third metal may improve a bond between the carrier and an oxide of the second metal, thereby improving the stability of the composite catalyst.

The heat treatment may be performed, for example, at a temperature of about 300° C. to about 900° C., about 400° C. to about 700° C., or about 500° C. to about 600° C. for about 1 hour to about 24 hours, about 2 hours to about 12 hours, or about 3 hours to about 6 hours. For example, the heat treatment may be for about 6 hours at a temperature that is greater than or equal to a melting point of the oxide of the third metal.

The second metal may be formed by reducing the precursor of the second metal.

The precursor of the second metal may be a salt of the second metal, specifically, a water-soluble salt of the second metal. For example, the precursor of the second metal may be chloroplatinic acid (H₂PtCl₆·6H₂O), platinum chloride (PtCl₄), tetra-amine platinum nitrate (Pt(NH₃)₄(NO₃)₂), platinum hydroxide (Pt(OH)₂), hydroxyl platinum ((NH₂—CH₂CH₂—OH)₂Pt(OH)₆), or any combination thereof.

The precursor of the second metal may be used in a content that is greater than 0 wt % to about 5 wt % based on to the total weight of the carrier including an oxide of a first metal.

A method of reducing the precursor of the second metal is not limited, but may be performed by treating in the presence of a reducing agent such as NaBH₄ or by performing heat treatment in a reducing atmosphere. In particular, since the oxide of the third metal is formed through heat treatment, the second metal may be formed by treating the precursor of the second metal with a reducing agent so as not to be affected by the heat treatment.

The oxide of the third metal may be formed by heat-treating the precursor of the oxide of the third metal.

The precursor of the oxide of the third metal may be a third metal-containing acid. For example, the precursor of the oxide of the third metal may include boric acid.

The precursor of the oxide of the third metal may be used in a content that is greater than 0 wt % to about 5 wt % based on the total weight of the carrier including the oxide of the first metal.

The precursor of the oxide of the third metal may be heat-treated in an oxidizing atmosphere, for example, at a temperature of about 300° C. to about 900° C., about 400° C. to about 700° C., or about 500° C. to about 600° C. for about 1 hour to about 24 hours, about 2 hours to about 12 hours, or about 3 hours to about 6 hours. Specifically, the precursor of the oxide of the third first metal may be heat-treated for about 6 hours at a temperature that is greater than or equal to a melting point of the oxide of the third metal.

The disclosure will be described in more detail using the following Examples and Comparative Examples, but the technical scope of the disclosure is not limited only to the following Examples.

### Examples

### Comparative Synthesis Example 1-1: Composite Catalyst (a)

A Pt precursor (H₂PtCl₆·6H₂O) and TiO₂ (ST-01 manufactured by ISHIHARA SANGYO KAISHA, LTD.) were combined in 15 milligrams (mg) of water such that a content of the Pt precursor was 1 wt % based on the total weight of TiO₂ and stirred at a temperature of 25° C. for 10 minutes. Next, 5 mg [0.15 moles per liter (M)] of a reducing agent (NaBH₄) solution was added and stirred at a temperature of 25° C. for 60 minutes, and then the solids were separated, rinsed several times with distilled water, and dried to provide a composite catalyst (a).

### Comparative Synthesis Example 1-2: Composite Catalyst (b)

The composite catalyst (a) obtained in Comparative Synthesis Example 1 was heat-treated at a temperature of 500° C. for 4 hours to provide a composite catalyst (b).

### Synthesis Example 1-1: Composite Catalyst (c)

A B₂O₃ precursor (H₃BO₃) and the composite catalyst (a) obtained in Comparative Synthesis Example 1-1 were combined in 5 mg of water such that a content of the B₂O₃ precursor was 0.75 wt % based on the total weight of the composite catalyst (a). Then, the resultant solids were dried and heat-treated at a temperature of 500° C. for 4 hours to provide a composite catalyst (c).

### Synthesis Example 1-2: Composite Catalyst (d)

A B₂O₃ precursor (H₃BO₃) and TiO₂ (ST-01 manufactured by ISHIHARA SANGYO KAISHA, LTD.) were combined in 5 mg of water such that a content of the B₂O₃ precursor was 0.75 wt % based on the total weight of TiO₂. The mixture was stirred at 25° C. for 10 minutes, and then the resultant solids were dried and heat treated at a temperature of 500° C. for 4 hours.

Here, a Pt precursor (H₂PtCl₆·6H₂O) was added to 15 mg of water such that a content of the Pt precursor was 1 wt % based on a total weight of TiO₂ and stirred at a temperature of 25° C. for 10 minutes, and then 5 mg (0.15 M) of a reducing agent (NaBH₄) solution was added and stirred at a temperature of 25° C. for 60 minutes. Then, the resultant solids were separated, rinsed with distilled water several times, dried, and heat-treated at a temperature 500° C. for 4 hours to provide a composite catalyst (d).

### Comparative Synthesis Example 2-1: Composite Catalyst (e)

A Pt precursor (H₂PtCl₆·6H₂O) and TiO₂ (ST-01 manufactured by ISHIHARA SANGYO KAISHA, LTD.) were combined in 15 mg of water such that a content of the Pt precursor was 2 wt % based on the total weight of TiO₂ and stirred at a temperature of 25° C. for 10 minutes. Next, 5 mg (0.15 M) of a reducing agent (NaBH₄) solution was added and stirred at a temperature of 25° C. for 60 minutes, and then the resultant solids were separated, rinsed several times with distilled water, dried, and heat-treated at a temperature 500° C. for 4 hours to provide a composite catalyst (e).

### Synthesis Example 2-1: Composite Catalyst (f)

A Pt precursor (H₂PtCl₆·6H₂O) and TiO₂ (ST-01 manufactured by ISHIHARA SANGYO KAISHA, LTD.) were combined in 15 mg of water such that a content of the Pt precursor was 2 wt % based on the total weight of TiO₂ and stirred at a temperature of 25° C. for 10 minutes. Next, 5 mg (0.15 M) of a reducing agent (NaBH₄) solution was added and stirred at a temperature of 25° C. for 60 minutes, and then the resultant solids were separated and rinsed several times with distilled water.

Here, a B₂O₃ precursor (H₃BO₃) was added along with 5 mg of water such that a content of the B₂O₃ precursor was 0.75 wt % based on a total weight of TiO₂. Then, stirring was performed at a temperature of 25° C. for 10 minutes, and then the resultant solids were dried without any change and heat-treated at a temperature of 500° C. for 4 hours to provide a composite catalyst (f).

### Synthesis Example 2-2: Composite Catalyst (g)

A B₂O₃ precursor (H₃BO₃) and TiO₂ (ST-01 manufactured by ISHIHARA SANGYO KAISHA, LTD.) were combined in 5 mg of water such that a content of the B₂O₃ precursor is 0.75 wt % based on the total weight TiO₂. Then, stirring was performed at 25° C. for 10 minutes, and then the resultant solids were separated, dried, and heat treated at a temperature of 500° C. for 4 hours.

Here, a Pt precursor (H₂PtCl₆·6H₂O) was added along with 15 mg of water such that a content of the Pt precursor was 2 wt % based on a total weight of TiO₂ and stirred at a temperature of 25° C. for 10 minutes. Next, 5 mg (0.15 M) of a reducing agent (NaBH₄) solution was added and stirred at a temperature of 25° C. for 60 minutes, and then the resultant solids were separated, rinsed several times with distilled water, dried, and heat-treated at a temperature 500° C. for 4 hours to provide a composite catalyst (g).

### Evaluation Example 1: SEM Analysis

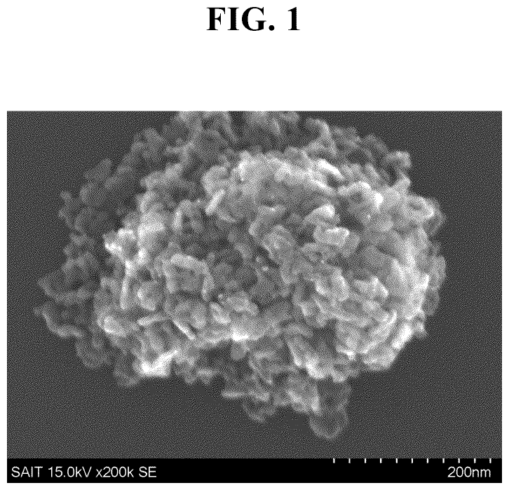

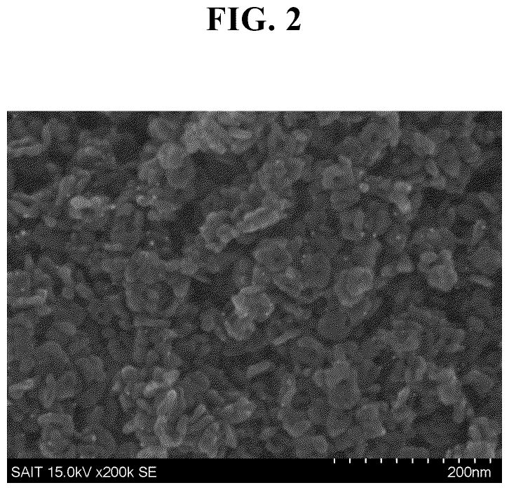

SEM images were acquired of the composite catalysts prepared in Comparative Synthesis Example 2-1 and Synthesis Example 2-1. Results thereof are shown in FIGS. 1 and 2, respectively.

FIG. 1 is the SEM image of the composite catalyst (e) prepared in Comparative Synthesis Example 2-1.

FIG. 2 is the SEM image of the composite catalyst (f) prepared in Synthesis Example 2-1.

### Evaluation Example 2: XRD Analysis

By using Quantum 2000 manufactured by Physical Electronics, Inc., X-ray photoelectron spectroscopy (XPS) elemental analysis was performed under conditions of an acceleration voltage of 0.5 kiloelectronvolts (keV) to 15 keV at 300 watts (W), a minimum analysis area of 200 micrometers (μm)×200 μm, and a sputter rate of 0.1 nanometers per minute (nm/min).

XPS analysis was performed on Comparative Synthesis Example 1-2, Synthesis Example 1-1, Synthesis Example 1-2, Comparative Synthesis Example 2-1, Synthesis Example 2-1, and Synthesis Example 2-2. Results thereof are shown in Table 1.

TABLE 1

| | Binding energy (eV) | | | | |
|---|---|---|---|---|---|
| Catalyst No. | B 1s | O 1s (I) | O 1s (II) | O 1s (III) | Ti 2p_{3/2} |
| Composite | — | 529.84 | 531.65 | — | 458.56 |
| catalyst (b) | | | | | |
| Composite | 191.95 | 529.84 | 531.36 | 531.99 | 458.65 |
| catalyst (c) | | | | | |
| Composite | — | 529.86 | 531.53 | — | 458.60 |
| catalyst (e) | | | | | |
| Composite | 191.57 | 529.96 | 531.36 | 532.22 | 458.77 |
| catalyst (f) | | | | | |

An O 1s (I) peak is due to a Ti—O bond of TiO₂, an O 1s (II) peak is due to a hydroxyl group (OH) present on a TiO₂ surface, and an O 1s (II) peak is due to a Ti—OB bond through formation.

### Evaluation Example 3: Measurement of Volatile Organic Compound (Formaldehyde) Removal Rate by Composite Catalyst

Each of the composite catalysts prepared in Comparative Synthesis Example 1-1, Comparative Synthesis Example 1-2, Synthesis Example 1-1, Synthesis Example 1-2, Comparative Synthesis Example 2-1, Synthesis Example 2-1, and Synthesis Example 2-2 was applied onto one side of a plate-shaped porous solid substrate to prepare a filter.

An air purification device including an inlet, an outlet, and a reaction chamber disposed between the inlet and the outlet, wherein air was supplied through the inlet and was discharged through the outlet. The filter was disposed between the inlet and the outlet to intersect an air flow moving from the inlet to the outlet within the reaction chamber. The filter was installed in the reaction chamber such that the composite catalyst was disposed upstream of the porous solid substrate in the air flow, thereby manufacturing the air purification device.

While a formaldehyde-containing gas was supplied to the inlet of the air purification device as a first compound and passed through the filter including a filter layer, and discharged, a conversion rate into carbon dioxide (CO₂) generated by decomposition of formaldehyde was measured in the outlet and shown in Table 2. A formaldehyde content of the formaldehyde-containing gas used in the measurement was 20 ppm, relative humidity was 50%, a temperature was 25° C., a linear velocity was 1.2 meters per second (m/s), and a space velocity was 1,200,000 milliliters per gram-hour (ml/g·hr). The formaldehyde-containing gas included 20% oxygen and 80% nitrogen.

TABLE 2

| | Pt precursor | B precursor | HCHO conversion |
|---|---|---|---|
| Catalyst No. | (wt %) | (wt %) | rate (%) |
| Composite | 1 | 0 | 44.6 |
| catalyst (a) | | | |
| Composite | 1 | 0 | 62.0 |
| catalyst (b) | | | |
| Composite | 1 | 0.75 | 64.5 |
| catalyst (c) | | | |
| Composite | 1 | 0.75 | 71.9 |
| catalyst (d) | | | |
| Composite | 2 | 0 | 67.3 |
| catalyst (e) | | | |
| Composite | 2 | 0.75 | 69.0 |
| catalyst (f) | | | |
| Composite | 2 | 0.75 | 77.7 |
| catalyst (g) | | | |

Referring to Table 2, as compared with the composite catalysts (a), (b), and (e) to which the B precursor was not added, in the composite catalysts (c), (d), (f), and (g) to which the B precursor was added, a formaldehyde conversion rate was improved.

In addition, as compared with the composite catalyst (c) in which the Pt precursor was first treated, and then the B precursor was treated, in the composite catalyst (d) in which the B precursor was first treated, and then the Pt precursor was processed, a formaldehyde conversion rate was improved. This is believed to be because B₂O₃ is first formed in the composite catalyst, thereby minimizing blocking of an active site of Pt.

A composite catalyst according to embodiments of the present invention may have improved selectivity, decomposition performance, removal performance, and/or reaction rate and thus may be applied to various indoor and outdoor air purification devices.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite catalyst comprising:
a carrier comprising an oxide of a first metal;
a second metal supported on the carrier; and
an oxide of a third metal supported on the carrier,
wherein an electronegativity of the first metal is less than or equal to an electronegativity of the third metal.

2. The composite catalyst of claim 1, wherein the first metal comprises Al, Si, a transition metal, or a combination thereof.

3. The composite catalyst of claim 1, wherein the oxide of the first metal is represented by a formula of MₐO_{b}, wherein M is Al, Si, Zr, Ti, or a combination thereof, 0<a≤4, and 0<b≤50.

4. The composite catalyst of claim 1, wherein the second metal comprises Pt, Pd, Rh, Ru, Ir, V, Mo, Mn, Ni, Co, Ce, Fe, W, Ag, Au, Cu, Sn, or a combination thereof.

5. The composite catalyst of claim 1, wherein the second metal comprises Pt, Pd, Rh, or a combination thereof.

6. The composite catalyst of claim 1, wherein the third metal comprises B, Al, Si, P, V, Cr, Mn, Fe, Co, Ni, Cu, Zn, Ga, Ge, Se, Nb, Mo, Tc, Ru, Rh, Pd, Ag, Cd, In, Sn, Sb, W, Ir, Bi, or a combination thereof.

7. The composite catalyst of claim 1, wherein the third metal comprises B, Al, or a combination thereof.

8. The composite catalyst of claim 1, wherein a content of the second metal is greater than 0 weight percent to about 5 weight percent, and a content of the oxide of the third metal is greater than 0 weight percent to about 5 weight percent based on a total weight of the composite catalyst.

9. The composite catalyst of claim 1, wherein a content of the oxide of the third metal is about 0.01 weight percent to about 2 weight percent based on a total weight of the composite catalyst.

10. The composite catalyst of claim 1, wherein the oxide of the first metal and the oxide of the third metal are chemically bonded on a surface of the carrier.

11. The composite catalyst of claim 1, wherein the composite catalyst is configured to remove a first compound from an unpurified air flow including the first compound.

12. The composite catalyst of claim 11, wherein the first compound comprises a volatile organic compound.

13. The composite catalyst of claim 12, wherein the volatile organic compound comprises a polar compound, a non-polar compound, or a combination thereof,
wherein the non-polar compound comprises an aliphatic hydrocarbon, an aromatic hydrocarbon, or a combination thereof, and
the polar compound comprises ammonia, urea, an amine compound, an aldehyde compound, a ketone compound, an alcohol compound, a sulfur compound, a thiol compound, a halogenated hydrocarbon, a nitrogen oxide, ozone, or a combination thereof,
wherein the aliphatic hydrocarbon comprises methane, ethane, propane, butane, pentane, hexane, or a combination thereof,
the aromatic hydrocarbon comprises benzene, toluene, xylene, or a combination thereof,
the amine compound comprises methylamine, dimethylamine, trimethylamine, ethylamine, aniline, or a combination thereof,
the aldehyde compound comprises formaldehyde, acetaldehyde, propiolaldehyde, butyraldehyde, or a combination thereof,
the ketone compound comprises dimethyl ketone, methyl ethyl ketone, diethyl ketone, methyl propyl ketone, dipropyl ketone, or a combination thereof,
the alcohol compound comprises methanol, ethanol, propanol, isopropanol, butanol, pentanol, hexanol, heptanol, or a combination thereof,
the sulfur compound comprises hydrogen sulfide, sulfur dioxide, elemental sulfur, a sulfur oxide, or a combination thereof, and
the thiol compound comprises methanethiol, ethanethiol, 1-propanethiol, 2-propanethiol, propenethiol, butanethiol, tert-butyl mercaptan, thiophenol, or a combination thereof.

14. The composite catalyst of claim 1, further comprising a substrate,
wherein the carrier is disposed on the substrate, and
the carrier and the substrate are disposed in an air flow stream, wherein the carrier is disposed upstream of the substrate in the air flow stream or the carrier and the substrate are disposed in parallel along at least a portion of the air flow stream.

15. An air purification device comprising:
a housing; and
the composite catalyst of claim 1,
wherein the composite catalyst is disposed in the housing.

16. A method of preparing a composite catalyst, the method comprising:
disposing a second metal and an oxide of a third metal on a carrier comprising an oxide of a first metal to provide the composite catalyst.

17. The method of claim 16, wherein the second metal and the oxide of the third metal are simultaneously disposed on the carrier,
the second metal is interposed between the carrier and the oxide of the third metal, or
the oxide of the third metal is interposed between the carrier and the second metal.

18. The method of claim 16, further comprising heat-treating the composite catalyst at a temperature that is greater than or equal to a melting point of the oxide of the third metal to provide a heat-treated composite catalyst.

19. The method of claim 16, further comprising reducing a precursor of the second metal to form the second metal.

20. The method of claim 16, further comprising heat-treating a precursor of the oxide of the third metal to form the oxide of the third metal.

21. A method for purifying air comprising:
providing the composite catalyst of claim 1;
contacting an unpurified air flow including a first compound with the composite catalyst; and
removing the first compound from the unpurified air flow with the composite catalyst to provide a purified air flow.
